(19) United States
(12) Patent Application Publication
(10) Pub. No.: US 2009/0173402 A1
(43) Pub. Date: Jul. 9, 2009

(54) SNUBBER VALVE

(75) Inventor: Surendhar Reddy Nalla, Duarte, CA (US)

Correspondence Address: KNOBBE MARTENS OLSON & BEAR LLP, 2040 MAIN STREET, FOURTEENTH FLOOR, IRVINE, CA, 92614, US

(73) Assignee: Pacific Scientific Company, Duarte, CA (US)

(21) Appl. No.: 12/328,598

(22) Filed: Dec. 4, 2008

Related U.S. Application Data
(60) Provisional application No. 60/992,642, filed on Dec. 5, 2007.

(51) Int. Cl. F16K 15/00

(52) U.S. Cl. 137/528

(57) ABSTRACT

A snubber valve provides velocity- and/or position-dependent mechanical snubbing. The snubber comprises pressure sensing pins controlling the position of a float that changes the cross section of a fluid flow channel in the valve. In some embodiments, the pins sense their position in the valve, controlling the position of a float that changes the cross section of a fluid flow channel in the valve. Also provided are methods for snubbing, for example, an aircraft door.

### PRIORITY INFORMATION

This application claims the priority benefit under 35 U.S.C. § 119(e) to U.S. Provisional Patent Application Ser. No. 60/992,642 (filed Dec. 5, 2007), the entirety of which is hereby expressly incorporated by reference herein.

### BACKGROUND

1. Field of the Invention

This disclosure relates generally to controlling mechanical motion, and more particularly, to devices and methods for mechanical snubbing.

2. Description of the Related Art

Snubber valves are used where snubbing or damping of motion is desired, for example, to control the speed and/or position of a device, to reduce stress on structural members, and the like. For example, forces acting on an aircraft door, for example, aircraft motion, wind, pressure differences, and the like, can cause rapid opening or closing of the door, which can present a hazard to passengers and crew. Furthermore, in reaching the end of the door's travel at high speed, the door can rebound or backlash, reversing direction and potentially closing on a user. Such a motion can also unduly stress the door hinges, mounting brackets, and the like, and potentially lead to component failure.

### SUMMARY OF THE INVENTION

Accordingly, one embodiment of the present invention comprises a snubber valve that provides velocity- and/or position-dependent mechanical snubbing. The snubber comprises pressure sensing pins controlling the position of a float that changes the cross section of a fluid flow channel in the valve. In some embodiments, the pins sense their position in the valve, controlling the position of a float that changes the cross section of a fluid flow channel in the valve. Also provided are methods for snubbing, for example, an aircraft door.

Other embodiments provide a snubber valve system comprising: a hollow, elongate snubber housing comprising an interior, a longitudinal axis, a first end, a second end, and an opening at the first end; a piston shaft extending longitudinally from the interior of the housing through the opening at the first end of the housing; a piston slidably disposed in the housing and secured to the piston shaft, the piston comprising a first side and a second side, defining a first chamber and a second chamber in the snubber housing; a fluid channel formed in the piston shaft, the fluid channel fluidly connecting the first chamber and the second chamber; and a displaceable float with at least two positions, the position of which responsive to a pressure difference between the first chamber and the second chamber, wherein when the float is the first position, the fluid channel has a first fluid flow cross section, and when the float is the second position, the fluid channel has a second fluid flow cross section.

Another embodiment of a snubber valve system comprises a hollow, elongate snubber housing comprising an interior, a longitudinal axis, a first end, a second end, and an opening at the first end. A piston shaft extends longitudinally from the interior of the housing through the opening at the first end of the housing. A piston is slidably disposed in the housing and secured to the piston shaft. The piston comprises a first side and a second side, defining a first chamber and a second chamber in the snubber housing. A fluid channel is formed in the piston shaft. The fluid channel fluidly connecting the first chamber and the second chamber.

A fluid restrictor is positioned within the piston shaft to restrict flow between the first chamber and the second chamber through the fluid channel. A bypass fluid channel fluidly connects the first and second chambers together. A pressure responsive valve positioned in the bypass fluid channel. The pressure responsive valve is configured to have a first flow condition when the pressure differential between the first chamber and second chamber is less than a selected threshold value and a second flow condition when the pressure differential between the first chamber and the second chamber is greater than the selected pressure value.

### BRIEF DESCRIPTION OF THE DRAWINGS

These and other features, aspects and advantages of the present inventions are described in connection with preferred embodiments, with reference to the accompanying drawings. The illustrated embodiments are merely examples and are not intended to be limiting.

FIG. 1A-1E illustrate cross sections an embodiment of a snubber valve in different configurations.

FIG. 2A illustrates an exploded view of another embodiment of a snubber valve. FIGS. 2B-2D illustrate cross sections of the snubber valve in different configurations.

FIGS. 3A and 3B illustrate cross sections of another embodiment of a snubber valve in different configurations.

FIG. 4 is a flowchart illustrating a method for snubbing using the snubber valve of FIG. 1A, 2A, or 3A.

FIG. 5A is a perspective view of an aircraft door incorporating a snubber valve. FIG. 5B is a top view of a door hinge arm comprising a snubber valve.

### DETAILED DESCRIPTION OF SOME PREFERRED EMBODIMENTS

The following description is directed to certain specific embodiments. Those skilled in the art will understand that the features can be embodied in a multitude of different ways, however. In this description, reference is made to the drawings wherein like parts are designated with like numerals throughout. As will be apparent from the following description, the embodiments may be implemented in any device in which mechanical snubbing or damping is desired.

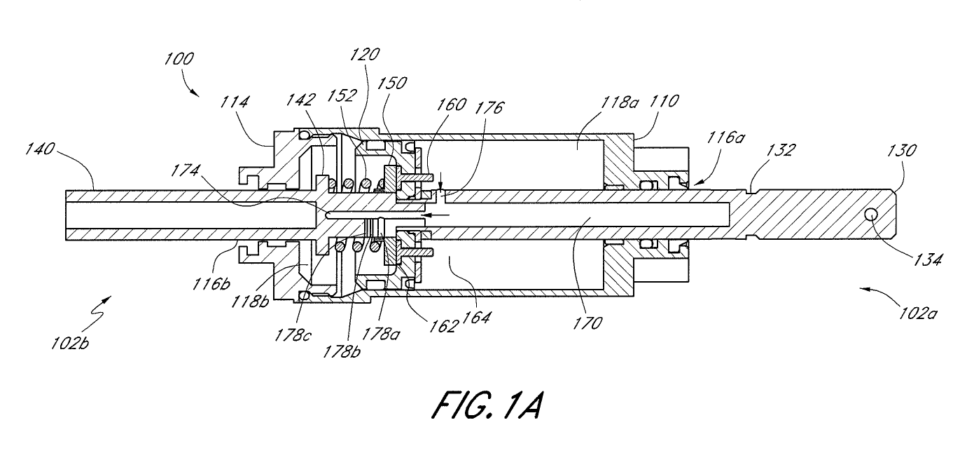

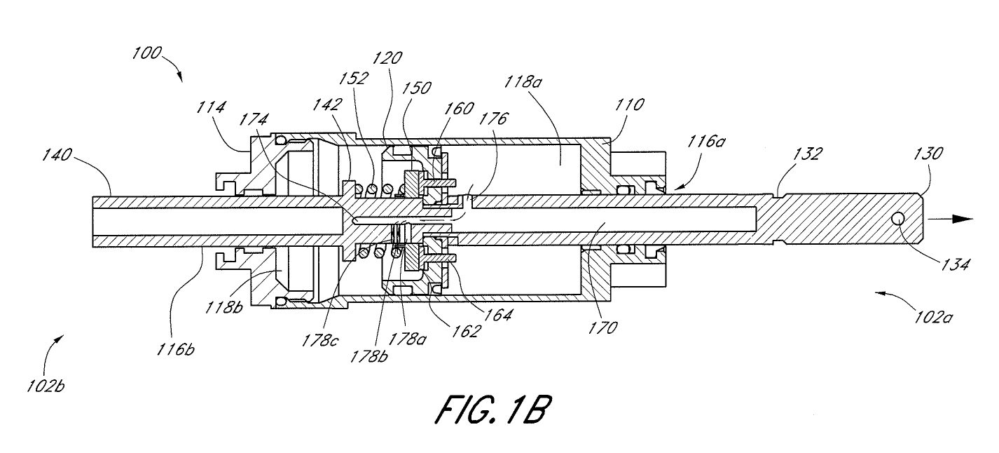

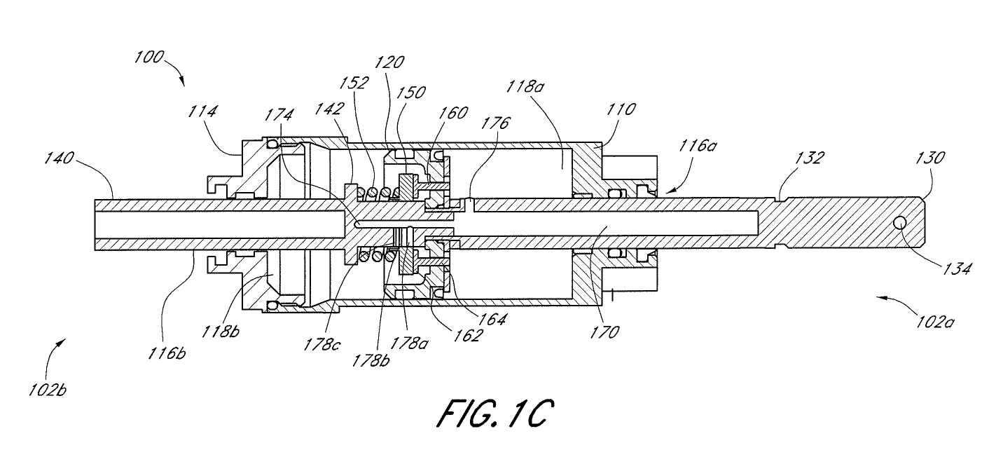

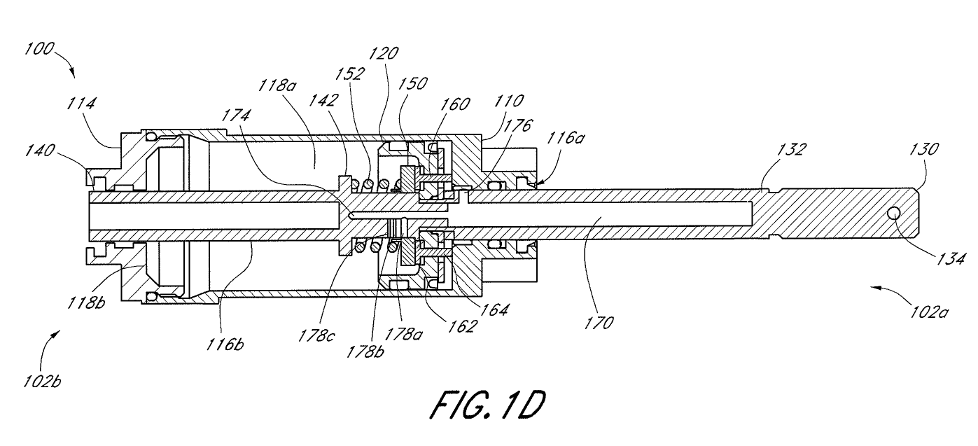

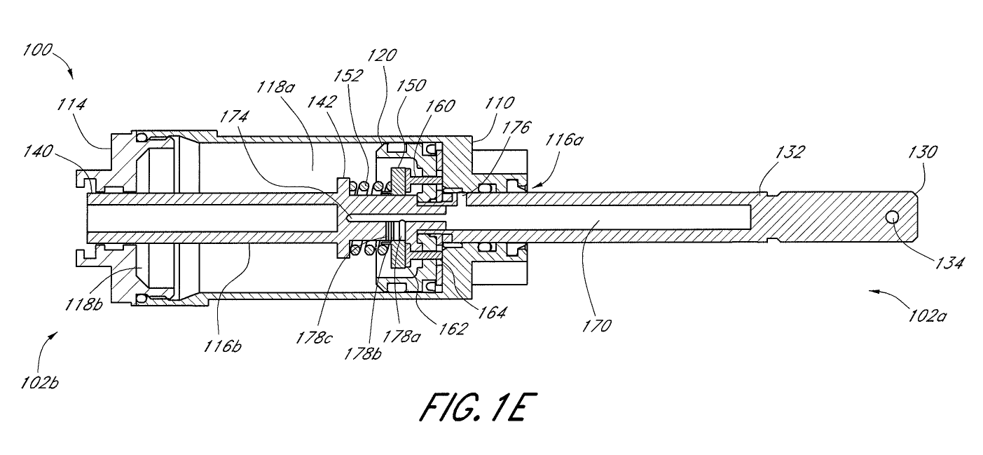

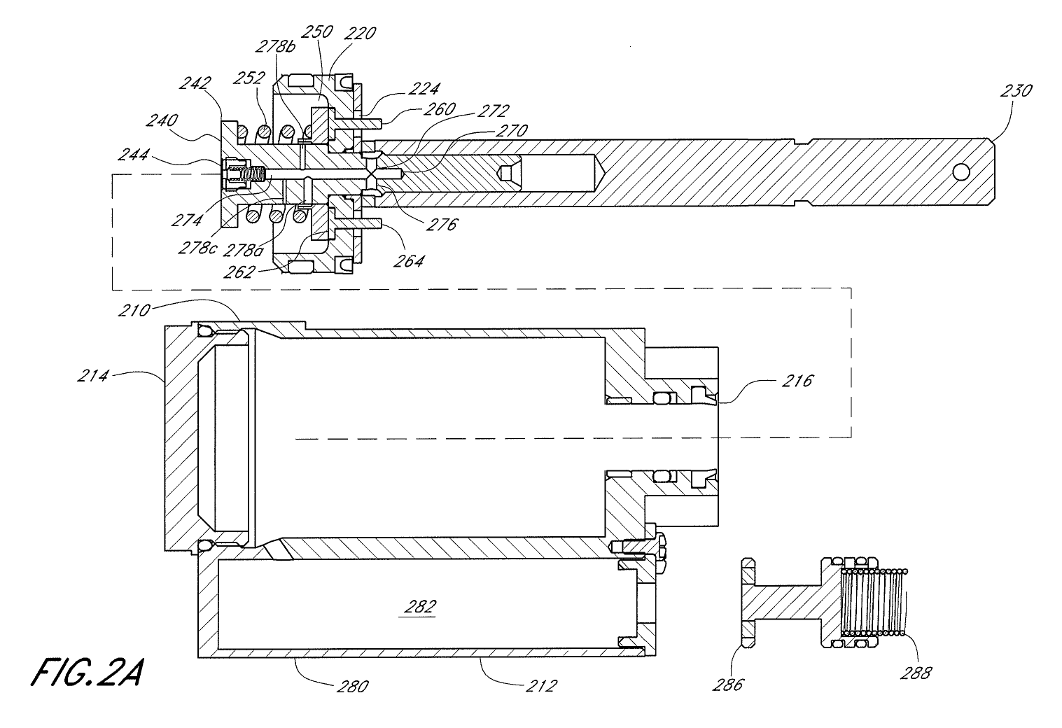

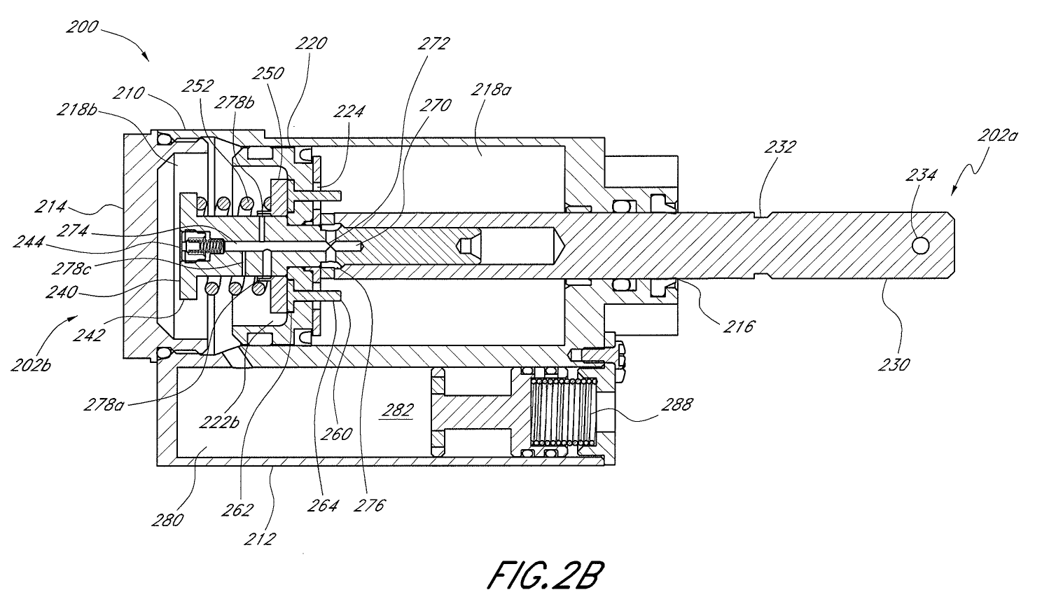

FIG. 1A illustrates in cross-section an embodiment of a snubber valve 100 in a first position. The snubber valve 100 comprises a first end 102a, a second end 102b, and a generally elongate housing 110 comprising a longitudinal axis and a hollow interior. In the illustrated embodiment the snubber housing 110 comprises an end cap 114 at the second end 102b, which is, for example, useful for assembling a snubber 100. In the illustrated embodiment, the snubber housing at the first end 102a comprises an opening 116a, generally coaxial with the longitudinal axis along which a snubber piston shaft 130 extends, as discussed in greater detail below. In the illustrated embodiment the snubber housing 110 is substantially cylindrical; however, those skilled in the art will understand that other shapes are used in other embodiments.

Disposed within the hollow interior of the snubber housing 110 is a piston 120, which divides the hollow interior of the snubber housing 110 into a first chamber 118a and second chamber 118b. In the illustrated embodiment the piston 120 is cup-shaped, with the cup open to the second chamber 118b. Those skilled in the art will understand that other shapes are also useful for the piston 120. The piston 120 is longitudinally displaceable back and forth within the snubber housing 110 between the first end 102a and to the second end 102b. The relative volumes of the first chamber 118a and the second chamber 118b vary with the displacement of the piston 120, as would be understood by one skilled in the art.

Extending from a first side 122a of the piston through the first chamber 108a is a first component of a snubber piston shaft 130, which, in the illustrated embodiment, extends along the longitudinal axis of the snubber housing 110 and exits the snubber housing 110 through the opening 116a in the first end. In the illustrated embodiment, a groove 132 and through hole 134 are provided for securing or coupling the snubber piston shaft 130 to a load. Other means for securing the snubber piston shaft 130 to a load are known in the art and used in other embodiments.

Extending from a second side 122b of the piston towards the second end 102b of the snubber housing is a second component of the snubber piston shaft 140, which together with the first component of the snubber piston shaft 130, form a snubber piston shaft or piston shaft. In the illustrated embodiment the second component of the snubber piston shaft 140 extends through an opening 116b formed in the end cap 114 of the snubber housing. A stop 142 spaced from the piston 120 is formed on the shaft of the second component of the snubber piston shaft 140.

In the illustrated embodiment, the center of the piston 120 is secured to the first component of the piston shaft 130. Those skilled in the art will understand that in other embodiments, the piston 120 is secured to one or both components of the piston shaft 140 and/or 130. In the illustrated embodiment, both components of the piston shaft 130 and 140 are both substantially cylindrical. Those skilled in the art will understand that other shapes are used in other embodiments. As will become apparent below, in the illustrated embodiment, both components of the piston shaft 130 and 140 have substantially similar cross sectional areas.

A float 150 is slidably mounted on the shaft of second component of the snubber piston shaft 140 between the piston 120 and stop 142. In the illustrated embodiment, the float 150 disposed within the cup formed on the second side 122b of the piston. A spring 152 disposed between the float 150 and the stop 142 urges the float 150 towards the piston 120 and pins 160.

A plurality of elongate pins 160 is slidably mounted in openings 124 formed in the piston 120. In the illustrated embodiment, each pin 160 is movable longitudinally in its respective opening 124, and comprises a head 162 that engages the opening 124, thereby limiting the movement of the pin 160 toward the first end 102a of the snubber. The movement of the pin 160 toward the second end 102b of the snubber is limited by the spring 152, as will be discussed in greater detail below. In the illustrated configuration, the head 162 of the pin is substantially flush with the second side 122b of the piston 120 and a shaft 164 of the pin extends through the opening 124 into the first chamber 118a. Those skilled in the art will understand that other arrangements are possible, for example, in which the head 162 of the pin extends into the second chamber 118b, or in which the head 162 of the pin is recessed into the opening 124. In the illustrated embodiment, the head 162 contacts the float 150. The shaft 164 of the pin has a substantially constant cross section that matches the shape of the opening 124, thereby limiting fluid passage through the opening 124. In preferred embodiments, the shaft 164 and opening 124 both have substantially circular cross sections.

The snubber valve further comprises a shaft fluid channel 170 fluidly connecting the first chamber 118a and the second chamber 118b through the snubber piston shaft. In the illustrated embodiment, the shaft fluid channel 170 comprises fluidly connected longitudinal bores 172 and 174, formed in the first and second components of the snubber piston shaft 130 and 140, respectively. One or more generally radial openings 176 fluidly connect the first chamber 118a to the bored portion 172. One or more radial openings 178 fluidly connect the second chamber 118b to the bored portion 174. In the illustrated embodiment, radial openings 178 comprise three openings 178a, 178b, and 178c longitudinally disposed on the second components of the snubber piston shaft 140. The opening 178a is proximal to the float 150 and has the largest diameter. The opening 178c has the smallest diameter and is disposed on the second components of the snubber piston shaft 140 closest to the second end 118b of the snubber valve. Opening 178b has an intermediate diameter and is disposed between openings 178a and 178c. In the illustrated embodiment, when the float 150 is in a first position proximal to the piston 120, the openings 176, bores 172 and 174, and openings 178 together define a first fluid flow cross section.

In the illustrated embodiment, the thickness of the float 150, and the diameters and spacing of openings 178a and 178b are selected to permit the float 150 to sequentially occlude only opening 178a in a second position, as well as both openings 178a and 178b in a third position as the float is displaced by the pins 160 toward the second end 118b of the snubber valve housing. The illustrated device is configured such that the float 150 does not occlude opening 178c. When the float 150 occludes opening 178a, the openings 178b and 178c, bores 172 and 174, and openings 176 together define a second fluid flow cross section. When the float 150 occludes openings 178a and 178b, the opening 178c, bores 172 and 174, and openings 176 together define a third fluid flow cross section. Those skilled in the art will understand that the first fluid flow cross section is larger than the second fluid flow cross section, which is in turn larger than the third fluid flow cross section. Accordingly, resistance to fluid flow increases from the first fluid flow cross section to the second fluid flow cross section, and increases further in the third fluid flow cross section, the function of which is described in greater detail below.

Those skilled in the art will understand that other arrangements for the shaft fluid channel 170 are used in other embodiments. For example, some embodiments comprise different numbers and/or arrangements of the openings 176 and/or 178. In some embodiments, one or more of the openings 178 comprises a longitudinally elongate slot, for example, with a constant width and/or a varying width, for example, a tapered width. In some embodiments, one or more of the openings 176 and/or 178 are not substantially radial, but are formed at another angle relative to the longitudinal axis.

The components of the snubber valve 100 comprise any suitable materials known in the art. For example, in some embodiments, one or more of the structural components comprises stainless steel, aluminum, aluminum alloy, and the like. Some embodiments further comprise one or more seals, wipers, and/or bearings of any suitable type.

The first chamber 118a, second chamber 118b, and shaft fluid channel 170 are filled with a suitable hydraulic fluid, for example, a silicone oil. In preferred embodiments, the hydraulic fluid is degassed and/or free of moisture.

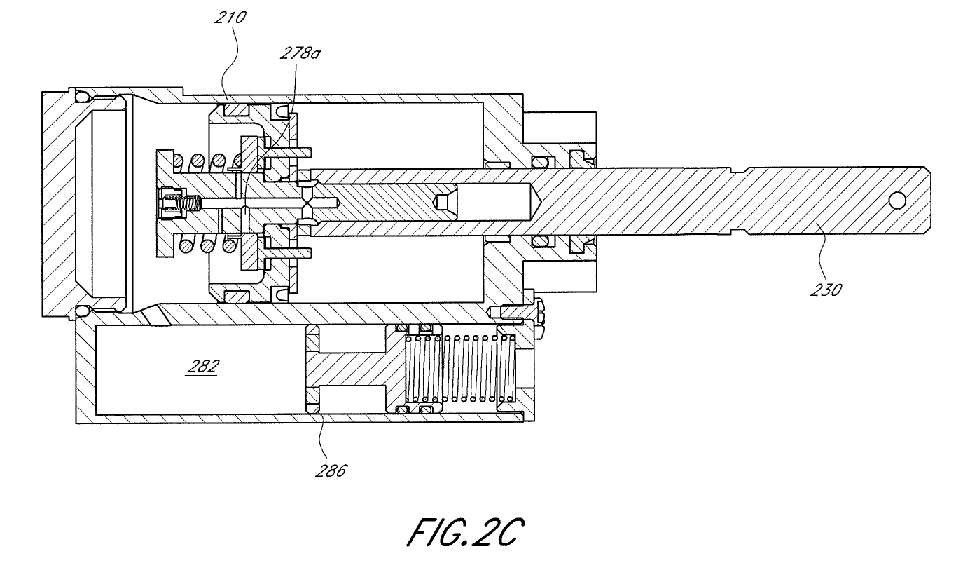

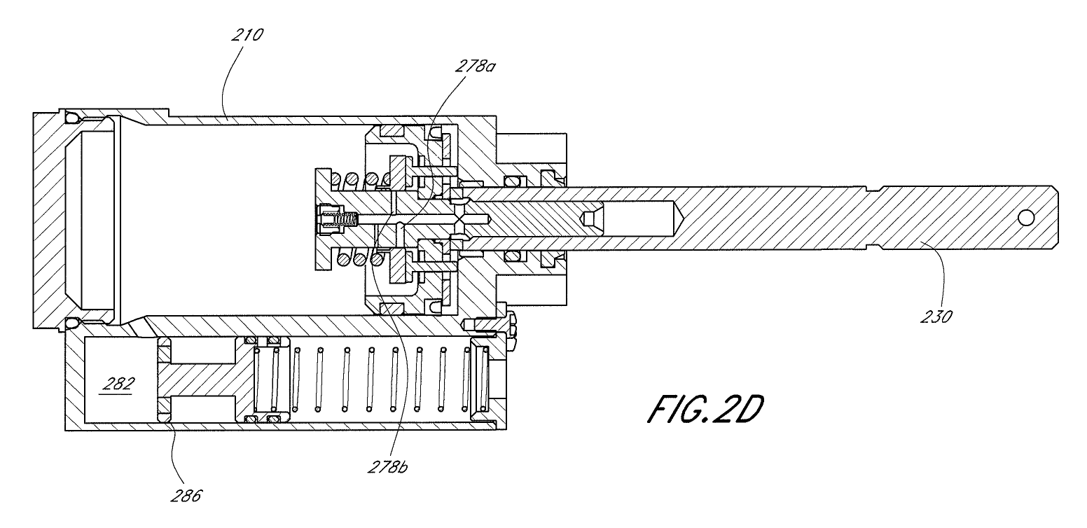

FIG. 2A illustrates an exploded view and FIG. 2B illustrates a cross section of another embodiment of a snubber valve 200 which is similar to the embodiment of the snubber valve 100 illustrated in FIG. 1A. The snubber valve 200 comprises a first end 202a and a second end 202b, and an elongate, hollow housing 210 comprising a longitudinal axis. An end cap 214 closes the second end 202b of the housing.

Within the hollow interior of the housing 210 is disposed a piston 220, which defines a first chamber 218a and second chamber 218b. Extending from the center of a first side 222a of the piston is a first component of a piston shaft 230, which extends along the longitudinal axis of the housing 210, through the first chamber 218a, and out an opening 216 at the first end 202a of the housing 210. In the illustrated embodiment, the first component of the piston shaft 230 comprises a groove 232 and through hole 234, which are used to secure a load thereto. A second component of the snubber piston shaft 240 extends from the center of a second side 222b of the piston into the second chamber 218b. In the illustrated embodiment, the second component of the snubber piston shaft 240 terminates in an enlarged stop 242. The first and second components of the piston shaft 230 and 240 together form a piston shaft or snubber piston shaft. In the illustrated embodiment, first and second components of the piston shaft 230 and 240 cooperatively secure the piston 220.

A float 250 is slidably mounted on the second component of the snubber piston shaft 240 proximal to the second side 222b of the piston. A spring 252 is disposed over the shaft of the second component of the snubber piston shaft 240 between the stop 242 and the float 250, and urges the float 250 against the second side 222b of the piston.

A plurality of pins 260 slidably extend through openings 224 in the piston. In the illustrated embodiments, the pins 260 comprise an enlarged head 262 and a shaft 264. In the illustrated embodiment, the shaft 264 is substantially cylindrical; however, those skilled in the art will understand that other shapes are also useful. The openings 224 are dimensioned such that the enlarged head 262 of the pin limits the travel of the pin 260 towards the first end 202a of the snubber. The openings 224 and pins 260 are also dimensioned and configured to limit or reduce fluid leakage through the openings 224 as the pins 260 move therein. The heads 262 of the pins bear against the float 250, which, as discussed above, is urged toward the piston 220 and pins 260 by the spring 252.

In the illustrated embodiment, a shaft fluid channel 270, fluidly connecting the first chamber 218a and second chamber 218b through the snubber shaft, comprises longitudinal bores 272 and 274 formed in the first and second components of the piston shaft 230 and 240, respectively. A plurality of radial openings 276 fluidly connects the bore 274 with the first chamber 218a. Another set of radial openings 278 fluidly connects bore 274 with the first chamber 218b.

In the illustrated embodiment, the openings 278 are both longitudinally and angularly distributed. For example, in the illustrated embodiment, openings 278a and 278c are disposed on the same side of the end rod 240, while the opening 278b is formed on the opposite side. The illustrated configuration permits openings 278a and 278b to overlap longitudinally, thereby making the device 200 more sensitive to pressure changes, as will become apparent below. In the illustrated embodiment, the diameters of the openings 278a, 278b, and 278c progressively decrease. In the illustrated embodiment, the diameters and spacing of openings 278a and 278b permit the float 250 in a first position along the end rod 240 to occlude opening 278a, and the float 250 in a second position to occlude both openings 278a and 278b. As with the embodiment described above, the float 250 and shaft fluid channel 270 together define at least three fluid flow cross sections.

A unidirectional flow valve 244 is disposed at the end of the longitudinal bore 274 proximal to the second end 204b of the snubber. The unidirectional flow valve 244 has an open configuration, which fluidly connects the longitudinal bore 274 with the second chamber 218b. The unidirectional flow valve 244 also has a closed configuration, which substantially prevents fluid flow between the longitudinal bore 274 and the second chamber 218b In the illustrated embodiment, the unidirectional flow valve 244 is configured to permit low resistance fluid flow from the second chamber 218b into the longitudinal bore 274, and ultimately, into the first chamber 218a, in the open configuration, but to resist fluid flow in the opposite direction in the closed configuration. Suitable unidirectional flow valves are known in the art, for example, check valves, ball check valves, swing check valves, clapper valves, leaf valves, lift-check valves, double ball check valves, piston check valves, wafer check valves, ball-and-cone check valves, one-way valves, and the like.

A reservoir 280 is disposed below the housing 210. In the illustrated embodiment, the reservoir 280 comprises a generally cylindrical, hollow reservoir housing 212 that is integrally formed with the snubber housing 210. The hollow interior of the reservoir housing 282 is fluidly connected to the second chamber 218b through a port 284 proximal to a first end of the reservoir housing 212. A reservoir piston 286 is slidably disposed in the reservoir housing 282 at a second end. A reservoir spring 288 urges the reservoir piston 286 toward the port 284.

In the illustrated embodiment, the reservoir 280 compensates for changes in the volume of the components of the device within the snubber housing 210 as the piston shaft 230 is withdrawn from and/or advanced into the snubber housing 210 in the illustrated embodiment. A reservoir is not needed in the embodiment illustrated in FIG. 1A and described above, because in that embodiment, the portions of first and second components of the piston shaft 130 and 140 that move into and out of the housing 110 have substantially identical cross sectional areas. Accordingly, changes in the volume of the first component of the piston shaft 130 within the first chamber 118a as the piston 120 is moved are compensated by changes in the volume of the second component of the piston shaft 140 within the second chamber 118b. Because the second component of the piston shaft 240 does not extend out of the snubber housing 210 in the embodiment illustrated in FIG. 2A, some embodiments of the snubber 200 are more compact than embodiments of the snubber 100.

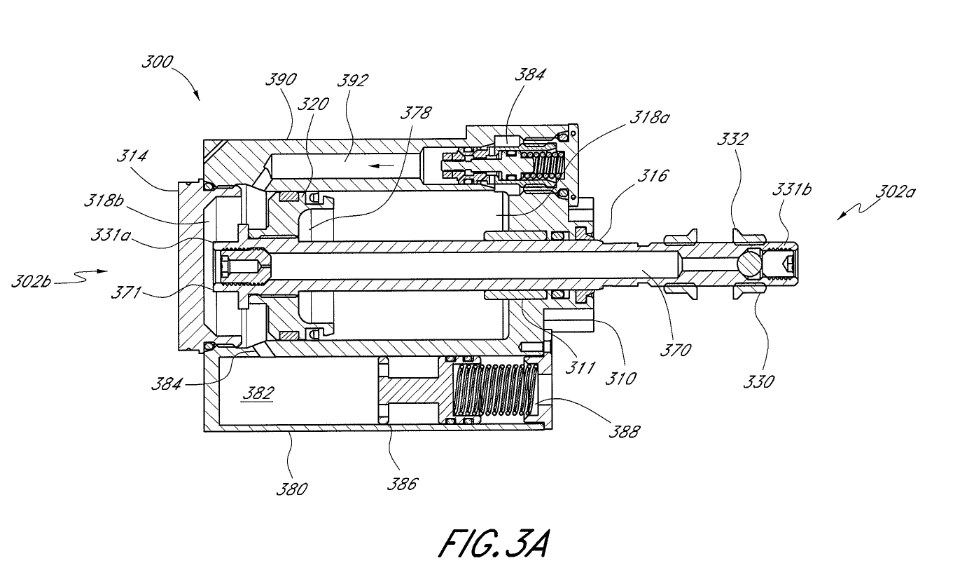

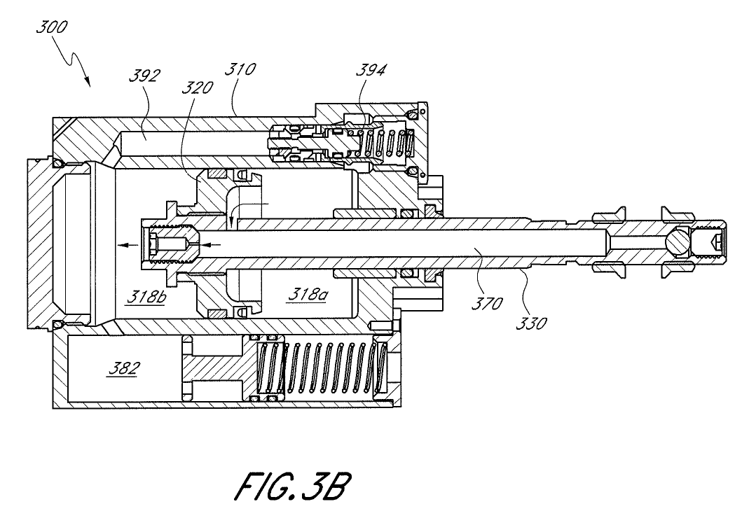

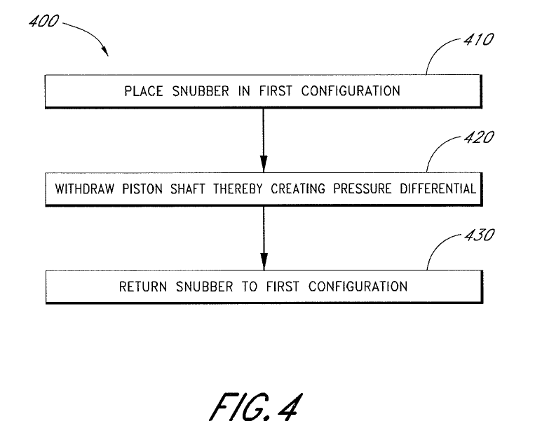

FIG. 3A illustrates a longitudinal cross section of another embodiment of a snubber valve 300, which comprises a first end 302a and a second end 302b. A hollow housing 310 comprises a longitudinal axis and is closed at the second end by an end cap 314. A piston 320 is disposed in the hollow interior of the housing 310, defining a first chamber 318a and second chamber 318b in the interior. The piston 330 is mounted near a first end 331a of a piston shaft 330, a second end 331b of which extends longitudinally through the first chamber 318a and through the housing 310 through an opening 316 at the first end 302a of the housing 310. The second end 331b of the piston shaft comprises a coupler 332 for mechanically coupling another component thereto. Other means known in the art are used for mechanically coupling the piston shaft 330 in other embodiments. In the illustrated embodiment, the second end 331b of the piston shaft further comprises a seal fitting.

A shaft fluid channel 370, which fluidly connects the first 318a and second 318b chambers, extends longitudinally through the length of the piston shaft 330 in the illustrated embodiment. Those skilled in the art will understand that the shaft fluid channel 370 does not extend the full length of the piston shaft 330 in other embodiments. A flow restrictor 371 disposed at the first end 331a of the piston shaft is selected to provide the desired fluid flow properties between the second chamber 318b and the shaft fluid channel 370. One or more openings 378 fluidly connect the shaft fluid channel 370 and the first chamber 318a. The dimensions of the opening(s) 378 are selected to provide the desired fluid flow properties.

A fluid reservoir 380 is provided adjacent to the housing 310, the reservoir 380 comprising a generally cylindrical, hollow reservoir housing 312, which in the illustrated embodiment, is integrally formed with the housing 310. The function of the reservoir 380 is discussed in greater detail above. The hollow interior of the reservoir housing 382 is fluidly connected to the second chamber 318b through a fluid port 384 proximal to a first end of the reservoir housing 312. A reservoir piston 386 and reservoir spring are disposed in the interior of the reservoir housing 382 proximal to a second end thereof. The reservoir piston 386 is slidable within the interior 382 of the reservoir housing in response to pressure changes in a within the snubber. The reservoir spring 388 urges the reservoir piston 386 toward the port 384.

At least one bypass fluid channel 390 formed in the housing 310 fluidly connects the first 318a and second 318b fluid chambers. The bypass fluid channel 390 comprises a bypass fluid channel 392 and a pressure responsive valve 394. In the illustrated embodiment, the pressure responsive valve 394 is disposed proximal to the first fluid chamber 318a; however, those skilled in the art will understand that other embodiments use other arrangements, for example, proximal to the second fluid chamber 318b or in an intermediate position. The pressure responsive valve 394 has at least two flow configurations, a higher flow configuration and a lower flow configuration. The particular flow configuration that the valve 394 assumes is responsive to a pressure differential between the first chamber 318a and the second chamber 318b. In the illustrated embodiment, the pressure responsive valve 394 comprises a check valve with an open configuration and a closed configuration. The check valve assumes the closed configuration when the pressure in the first chamber 318a is greater than the second chamber 318b by a selected threshold value. When the pressure differential between the first chamber 318a and the second chamber 318b is less than the threshold value, the check valve assumes the open configuration. In the illustrated embodiment, the check valve remains in the open configuration when fluid flows from the second chamber 318b to the first chamber 318a.

In other embodiments, the pressure responsive valve 394 has more than two flow configurations. In some embodiments, the pressure responsive valve 394 has at least one configuration with a flow intermediate between the high flow and the low flow position. For example, in some embodiments, the flow through the pressure responsive valve 394 varies continuously with the pressure differential between the higher flow configuration and the lower flow configuration. In other embodiments, the pressure responsive valve 394 has a plurality of discrete flow configurations. Other embodiments have both discrete flow and continuously variable flow configurations. Those skilled in the art will understand that a device with greater than two flow configurations may also be realized using a plurality of pressure responsive valves, either in a single bypass fluid channel and/or in a plurality of bypass fluid channels.

In the illustrated embodiment, the lower flow configuration of the pressure responsive valve permits substantially no flow from the first chamber 318a to the second chamber 318b. In other embodiments, the lower flow configuration permits some fluid flow from the first chamber 318a to the second chamber 318b.

As described in detail below, the pressure responsive valve 394 provides snubbing when the pressure in the first chamber 318a exceeds the pressure in the second chamber 318b by a selected value. Those skilled in the art will understand that in other embodiments, the pressure responsive valve 394 provides snubbing in the opposite direction, that is, when the pressure in the second chamber 318b exceeds the pressure in the first chamber 318a by a selected value. Other embodiments provide snubbing in both directions.

In the illustrated embodiment, the first end 302a of the housing 310 can include a sleeve 311. When the piston 320 reaches the end of its stroke to the first end 302a, the sleeve 311 can cover one or more axially displaced opening 478 positioned on the shaft and/or cover one or more openings circumferentially spaced along the shaft 330. In this manner, as the piston 320 reaches the end of the stroke one or more openings 378 can be covered (leaving preferably at least one opening open) providing a snubbing effect at the end of the stroke.

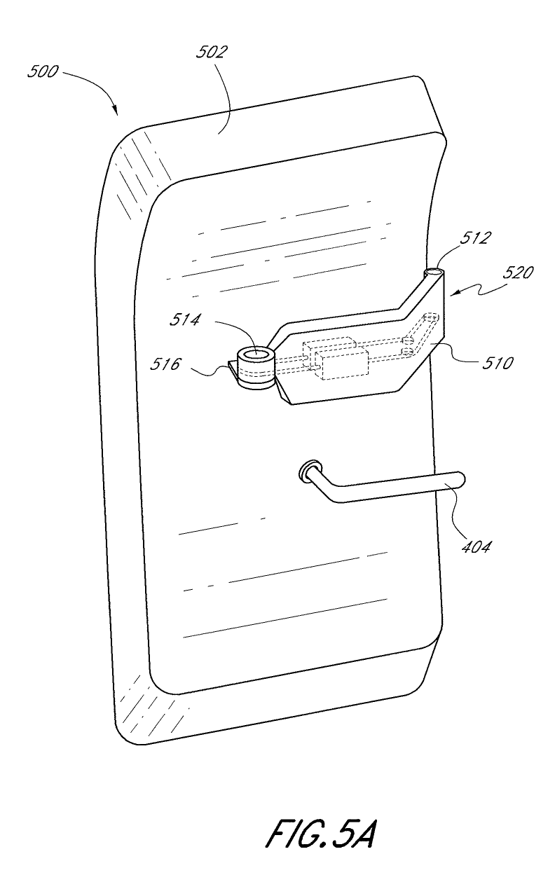

A method 400 for snubbing or damping a longitudinal motion of a load secured to a snubber valve is illustrated as a flowchart in FIG. 4 with reference to the snubber valve 100 illustrated in FIGS. 1A-1E, although those skilled in the art will understand that the method is also applicable to snubbers of other design, for example, those illustrated in FIGS. 2A-2D and 3A-3B. In step 410, the snubber valve 100 is placed into a first configuration in which the snubber piston shaft 130 is retracted into the snubber housing 110, for example, the configuration illustrated in FIG. 1A. In the illustrated embodiment, the stop 142 limits the travel of the snubber piston shaft 130 toward the second end 112b of the snubber valve.

In step 420, the snubber piston shaft 130 is withdrawn longitudinally from the snubber body 110, for example, by a load secured to the snubber piston shaft 130. The piston shaft 130 in turn pulls the piston 120 towards the first end 102a of the snubber, thereby increasing the pressure in the first chamber 118a and decreasing the pressure in the second chamber 118b. The pressure differential causes fluid to travel from the first chamber 118a to the second chamber 118b through the shaft fluid channel 170, as illustrated by the arrows in FIG. 1A. In the illustrated embodiment, the limited cross sectional area of the openings 178 limits the fluid flow through the shaft fluid channel 170, thereby resulting in some snubbing or damping of the extension of the piston shaft 130. Other embodiments provide no snubbing at low piston shaft 130 velocities. Accordingly, at low velocities, the snubber 100 is in a low or non-snubbing configuration.

As the velocity of the piston shaft 130 increases, the pressure differential between the first chamber 118a and the second chamber 118b increases. The pressure differential pushes the pins 160 against the float 150, which moves along the shaft of the end rod 140 to the position illustrated in FIG. 1B, in which the float 150 occludes the opening 178a, further reducing the flow through the shaft fluid channel 170 into the second chamber 118b and providing additional snubbing compared with the configuration illustrated in FIG. 1A. Occluding opening 178a provides an intermediate snubbing configuration.

At even higher velocities, the pressure differential between the first chamber 118a and the second chamber 118b forces the pins 160 even further into the second chamber 118b, thereby pushing the float 150 into the position illustrated in FIG. 1C in which both openings 178a and 178b are occluded, thereby providing even greater snubbing, which is referred to as a fully snubbing configuration. In the illustrated embodiment, the spring 152 prevents the float 150 from occluding opening 178c.

Those skilled in the art will understand that the profile of snubbing from a low or non-snubbing configuration to an intermediate snubbing configuration to a fully snubbing configuration is different in other embodiments. For example, some embodiments comprise additional openings 178 as discussed above, which provide a profile with additional intermediate snubbing configurations. Also, as discussed above, some embodiments comprise at least one opening 178 with a shape that modifies the snubbing profile, for example, a slot, a tapered slot, or the like.

Another feature of the illustrated snubber 100 is illustrated in FIG. 1D. As the piston shaft 130 approaches the end of its travel, the pins 160 contact the snubber housing 110, urging the float 150 into the illustrated position, thereby occluding opening 178a, thereby providing intermediate snubbing when the piston shaft is 130 in the illustrated position, irrespective of velocity. When the piston shaft 130 reaches the end of its travel, the pins 160 push the float 150 into the position illustrated in FIG. 1E, thereby providing full snubbing at the end of the piston shaft's 130 travel.

In step 430, the piston shaft 130 is returned to the initial configuration illustrated in FIG. 1A. In returning to this configuration, fluid flows through the shaft fluid channel 170 from the second chamber 118b to the first chamber 118a. The float 150 is urged against the piston 120, thereby permitting fluid flow through all of the openings 178.

The snubber 200 illustrated in FIGS. 2A-2E is also operable using the method 300 illustrated in FIG. 3. In step 410, the snubber 200 is in the configuration illustrated in FIG. 2B, with the piston shaft 230 fully retracted into the snubber housing 210.

In step 420, the piston shaft 230 is withdrawn. FIG. 2B illustrates the configuration of the snubber 200 at low piston shaft 230 velocities, in which the float 250 remains proximal to the piston 240, thereby not occluding any of the openings 278. The fluid flow is indicated by arrows. At these low velocities, there is little or no snubbing, and accordingly, the illustrated configuration in which the float 250 does not occlude any of the openings is referred to as a low or non-snubbing configuration. As the velocity of the piston shaft 230 increases, the pressure differential between the first chamber 218a and the second chamber 218b pushes the pins 260 towards the second chamber 218b; thereby urging the float 250 into the position illustrated in FIG. 2C in which the opening 278a is occluded. This configuration is referred to as an intermediate snubbing configuration. At higher velocities, the pins 260 urge the float 250 into the position illustrated in FIG. 2D, in which both the openings 278a and 278b are occluded, which is referred to as a fully snubbing configuration. When the piston shaft 230 reaches the end of its travel, the pins 260 contact the snubber housing 210, urging the float 250 into a position that occludes first opening 278a (intermediate snubbing), then both openings 278a and 278b in a fully snubbing configuration illustrated in FIG. 2D. Note the movement of the reservoir piston 286 in FIGS. 2A-2D, which compensates for the volume change of the piston shaft 230 in the housing 210 as the piston shaft 230 is withdrawn.

In step 430, the piston shaft 230 is reinserted into the snubber housing 210. In the illustrated embodiment, the pressure differential between the second chamber 218b and the first chamber 218a causes the unidirectional flow valve 244 to open, reducing resistance to the motion of the piston 220, thereby reducing or eliminating snubbing in this step.

The method 400 is also applicable to the operation of the snubber 300 illustrated in FIGS. 3A and 3B. In step 410, the snubber 300 is placed in an initial configuration, for example, the configuration illustrated in FIG. 3A. In this position, the pressure responsive valve 394 is in a high flow position or configuration, thereby permitting fluid flow through the bypass fluid channel 392. A tensile, longitudinal load is secured to the snubber using coupler 332.

In step 420, the piston shaft 330 is withdrawn from the snubber housing 310 by the load (toward the right in configuration illustrated in FIG. 3A) secured thereto. The piston 320 moves in concert with the piston shaft 320, thereby reducing the volume in the first chamber 318a and increasing the volume in the second chamber 318b. The volume changes establish a pressure differential between the first chamber 318a and the second chamber 318b in the fluid filling the snubber valve 300. At low piston 320 velocities, the pressure differential is below the threshold of the pressure responsive valve 394, which remains in the initial, high flow configuration. Consequently, the pressure differential between the first chamber 318a and the second chamber 318b is equalized primarily by fluid flow (indicated by arrows in FIG. 3A) through the bypass fluid channel 392. Some fluid also flows from the first chamber 318a to the second chamber 318b through the shaft fluid channel 370. In the illustrated embodiment, however, the majority of fluid travels through the bypass fluid channel 392. Accordingly, the configuration illustrated in FIG. 3A provides low or no snubbing and is referred to as a low or non-snubbing configuration.

As the piston 320 velocity increases, the pressure differential between the first chamber 318a and the second chamber 318b increases to the threshold value at which the pressure responsive valve 394 adopts the low flow configuration, as illustrated in FIG. 3B. In the illustrated embodiment, the pressure responsive valve 394 in the low flow configuration permits substantially no fluid flow therethrough. In the embodiment illustrated FIG. 3B, at high piston 320 velocities, the pressure differential between the first chamber 318a and the second chamber 318b is equalized substantially solely through fluid flow through the shaft fluid channel 370, as illustrated by the arrows in FIG. 3B. The reduced overall fluid flow in the low-flow configuration illustrated in FIG. 3B compared with the configuration illustrated in FIG. 3A produces the snubbing of the valve 300. Accordingly, the configuration illustrated in FIG. 3B is also referred to as a snubbing configuration.

In step 430, the snubber 300 is returned to the initial configuration illustrated in FIG. 3A. As the piston shaft 330 returns to its initial position, the moving piston 320 reduces the volume of the second chamber 318b while increasing the volume of the first chamber 318a, thereby increasing the pressure in the second chamber 318b relative to the first chamber 318a. In the illustrated embodiment, the pressure responsive valve 394 returns to the high flow configuration illustrated in FIG. 3A under these pressure conditions, thereby permitting the piston shaft 330 and piston to return to their initial positions as illustrated in FIG. 3A without snubbing. Those skilled in the art will understand that other embodiments of the snubber 300 provide snubbing in all or part of step 430, which can greater or less than the snubbing provided in step 420.

The snubber valve is useful in any application in which snubbing or damping of linear motion is desired, for example, in struts, aircraft landing gear, shock absorbers, and the like. By way of example, the use of a snubber valve 100, illustrated in FIGS. 1A-1E and described above, in controlling motion in an aircraft door is described. Those skilled in the art will understand that other embodiments, for example, the embodiments 200 and 300, illustrated in FIGS. 2A-2D, and FIGS. 3A and 3B, and described above, are also useful in this application.

Aircraft doors used for passenger and/or cargo access often swing outward, then along an outer wall of the fuselage. These doors are typically heavy for their size. Rapid motion of an aircraft door, for example, induced by operation of the door, wind, gravity, and/or aircraft motion, can present a number of hazards, for example, to passengers, crew, and/or cargo. A rapidly moving door reaching a limit of motion, for example, of a hinge or linkage, can damage the door, hinge, linkage, or even fuselage of the aircraft. Snubbing at the limit of travel reduces the forces on these components, thereby reducing the likelihood of damage thereto. Incorporating a snubber valve in the door mechanism can reduce or prevent rapid door motion, thereby reducing injuries and/or damage to the aircraft itself.

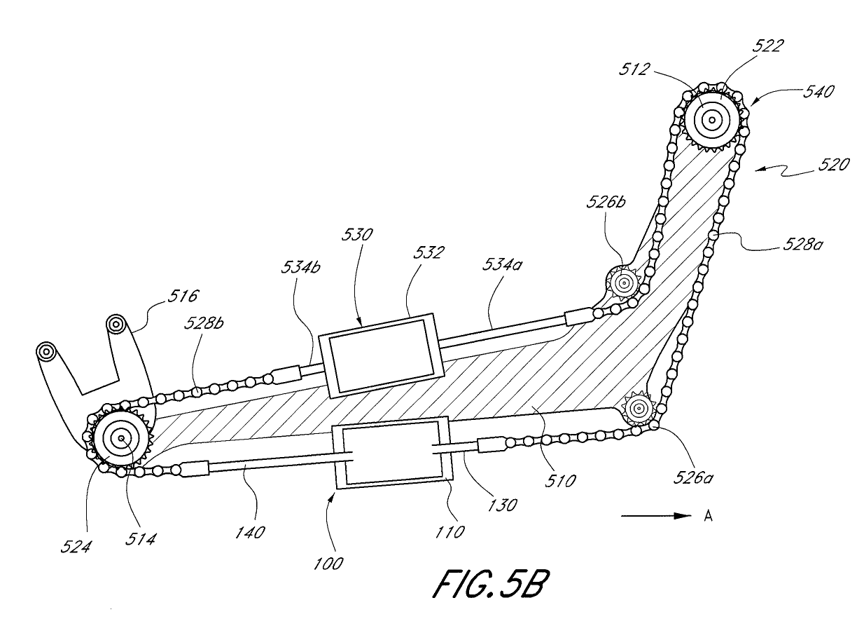

FIG. 5A illustrates a perspective view of the interior of an embodiment of an aircraft translating passenger door system 500 comprising a door 502, a door operating handle 504, and an angled hinge arm 510. The hinge arm 510 is of any type known in the art. A first hinge pin 512 pivotably secures the hinge arm 510 to the airframe. A second hinge pin 514 pivotably secures the hinge arm 510 to a door bracket 516, which is secured to the door 502. The door operating handle 504 and hinge arm 510 are disposed on the side of door 502 facing the interior of the aircraft.

FIG. 5B illustrates a top view of the hinge arm 510 and a system 520 for controlling the opening and closing of the door 502 mounted thereon. In the illustrated embodiment, the system 520 comprises a snubber 100 of the type illustrated in FIGS. 1A-1E, a linear pneumatic actuator 530, and a linkage system 540, which converts the rotational motion of the opening and closing of the door 502 into a translational motion that moves the door 502 away from the fuselage as the door 502 is opened and back toward the fuselage as the door 502 is closed. In the illustrated embodiment, the linkage system 540 comprises a roller chain system. Those skilled in the art will understand that other linkages are also useful in the system 520, for example, a bell crank mechanism.

The linear pneumatic actuator 530 is of any type known in the art for pneumatically opening an aircraft door, for example, in an emergency. In the illustrated embodiment, the linear pneumatic actuator 530 comprises an actuator body 532 and an actuator rod passing therethrough comprising a first end 534a and a second end 534b. Typically, the linear pneumatic actuator 530 is used only to open the door 502 in an emergency and does not interfere or contribute to the normal operation of the door 502. In the illustrated embodiment, the snubber housing 110 and pneumatic actuator body 532 are secured to opposite sides of the hinge arm 510.

In the illustrated embodiment, the linkage system 540 comprises a first hinge gear 522 mounted in the first hinge pin 512, and a second hinge gear 524 mounted on the second hinge pin 514. Idler gears 526a and 526b are mounted on the hinge arm 510 proximal to the angle therein. The first end of the actuator rod 534a and the first component of the piston shaft 130 of the snubber are linked through a first roller chain 528a. Between the first end of the actuator rod 534a and the first component of the piston shaft 130, the first roller chain 528a wraps around the first idler gear 526a, the first hinge gear 522, and the second idler gear 526b. The first and second idler gears 526a and 526b guide the first roller chain 528a in a path approximating the angled geometry of the hinge arm 510, thereby resulting in a compact assembly. The second end of the actuator rod 534b and the second component of the piston shaft 140 of the snubber are linked through a second roller chain 528b, which wraps around the second hinge gear 524.

The operation of the linkage system 540 in normal operation is as follows. In normal use, the handle 504 of the door is manually rotated, thereby unlocking the door 502. As the door 502 is opened, the hinge arm 510 rotates around the first hinge pin 512. This rotational motion is converted by the first hinge gear 522 and first roller chain 528a into translational or linear motion, which is transferred to the second roller chain 528b through the actuator 530 and snubber 100. The translational motion of the second roller chain 528b is reconverted into rotational motion of the door bracket 516 by the second hinge gear 524. Accordingly, as the hinge arm 510 is rotated around the first hinge pin 512, the door 502 is rotated an equal amount around the second hinge pin 514, thereby maintaining the door 502 approximately parallel to the aircraft fuselage on opening and closing.

In emergency usage, the pneumatic actuator 530 is activated, thereby opening the door 502. The linkage 540 operates as described above in this situation.

As discussed above, the snubber piston shaft 130 and 140 is subjected to a translational motion with a direction indicated by the arrow A when the door 502 is opened. Those skilled in the art will understand that the velocity of the motion of the piston shaft 130 and 140 will depend on the velocity of the door 502. As discussed above, the snubbing increases with increasing velocity.

At low door 502 velocities, the snubber 100 is in a low or non-snubbing configuration as described above and illustrated in FIG. 1A. In particular, the pressure differential between the first chamber 118a (FIG. 1A) and the second chamber 118b is insufficient to cause the float 150 to occlude any of the openings 178 formed in the second component of the piston shaft 140. As the speed of the door 502 increases, the snubbing increases as the snubber adopts intermediate and/or fully snubbing configurations in which the float 150 occludes at least one of openings 178a and 178b, as illustrated in FIGS. 1B and 1C.

Some embodiments, provide increased snubbing at and/or near the limit of the travel of the door 502, thereby reducing damage resulting from the door 502 suddenly reaching the limit of travel. The snubbing also reduces backlash, which reduces injuries to passengers and crew. In some of these embodiments, the linkage system 540 is configured to take advantage of a snubber that provides increased snubbing based on position, for example, the snubber 100 illustrated in FIGS. 1A-1E. In some embodiments, the linkage system 540 is configured such that the snubber 100 adopts an intermediate and/or fully snubbing configuration, for example, as illustrated in FIGS. 1D and 1E as the door 502 approaches the limit of travel.

Those skilled in the art will understand that changes in the systems, devices, and methods described above are possible, for example, adding and/or removing components and/or steps, and/or changing their orders. While the above detailed description has shown, described, and pointed out novel features of various embodiments, it will be understood that various omissions, substitutions, and changes in the form and details of the device or method illustrated may be made by those skilled in the art. As will be recognized, some embodiments do not provide all of the features and benefits set forth herein, as some features may be used or practiced separately from others.

What is claimed is:

1. A snubber valve system comprising:
a hollow, elongate snubber housing comprising an interior, a longitudinal axis, a first end, a second end, and an opening at the first end;
a piston shaft extending longitudinally from the interior of the housing through the opening at the first end of the housing;
a piston slidably disposed in the housing and secured to the piston shaft, the piston comprising a first side and a second side, defining a first chamber and a second chamber in the snubber housing;
a fluid channel formed in the piston shaft, the fluid channel fluidly connecting the first chamber and the second chamber; and
a displaceable float with at least two positions, the position of which responsive to a pressure difference between the first chamber and the second chamber,
wherein
when the float is the first position, the fluid channel has a first fluid flow cross section, and
when the float is the second position, the fluid channel has a second fluid flow cross section.

2. The snubber valve system of claim 1, wherein the fluid channel includes a plurality of axially separated openings that are positioned on a portion of the piston shaft within the second chamber.

3. The snubber valve system of claim 2, wherein when the float is in the first position none of the axially separated openings are covered by the displaceable float and in the second position at least one of the plurality of axially separated openings is covered by the displaceable float.

4. The snubber valve system of claim 3, wherein the system comprises at least three axially separated plurality openings and wherein in a third position at least two of the plurality of axially separated openings are covered by the displaceable float.

5. The snubber valve system of claim 1, wherein at least two of the plurality of axially separated openings are located on opposite sides of the piston shaft.

6. The snubber valve system of claim 1, wherein the piston shaft extending longitudinally from the interior of the housing through an opening at the second end.

7. The snubber valve system of claim 1, further comprising unidirectional flow valve in the piston shaft.

8. The snubber valve system of claim 1, wherein the unidirectional flow valve permits flow into the second chamber but prevents flow into the piston shaft from the second chamber.

9. The snubber valve system of claim 1, further comprising a spring extending over the shaft to bias the displaceable float against the piston.

10. The snubber valve system of claim 1, wherein the piston shaft does not extend through the second end of the housing and the snubber valve system further comprising a reservoir in fluid connection with the second chamber.

11. The snubber valve system of claim 10, further comprising a reservoir piston slideably position within the reservoir.

12. The snubber valve system of claim 1, further comprising at least one pin that extends through an opening in the piston into the first chamber and is positioned between the displaceable float and the piston such that an increase in pressure in the first chamber pushes the pins into the second chamber.

13. A snubber valve system comprising:
a hollow, elongate snubber housing comprising an interior, a longitudinal axis, a first end, a second end, and an opening at the first end;
a piston shaft extending longitudinally from the interior of the housing through the opening at the first end of the housing;
a piston slidably disposed in the housing and secured to the piston shaft, the piston comprising a first side and a second side, defining a first chamber and a second chamber in the snubber housing;
a fluid channel formed in the piston shaft, the fluid channel fluidly connecting the first chamber and the second chamber;
a fluid restrictor positioned within the piston shaft to restrict flow between the first chamber and the second chamber through the fluid channel;
a bypass fluid channel fluidly connecting the first and second chambers together; and
a pressure responsive valve in the bypass fluid channel, the pressure responsive valve configured to have a first flow condition when the pressure differential between the first chamber and second chamber is less than a selected threshold value and a second flow condition when the pressure differential between the first chamber and the second chamber is greater than the selected pressure value.

14. The snubber valve system of claim 13, wherein the fluid channel includes a plurality of separated openings that are positioned on a portion of the piston shaft within the first chamber.

15. The snubber valve system of claim 14, wherein when the piston is displaced separated openings are covered by a sleeve through which the piston shaft extends.

16. The snubber valve system of claim 14, wherein at least two of the plurality of axially separated openings are located on opposite sides of the piston shaft.

17. The snubber valve system of claim 13, wherein the piston shaft does not extend through the second end of the housing and the snubber valve system further comprising a reservoir in fluid connection with the second chamber.

18. The snubber valve system of claim 17, further comprising a reservoir piston slideably position within the reservoir.

19. The snubber valve system of claim 13, wherein the pressure responsive valve is closed in the second condition.

20. The snubber valve system of claim 13, wherein the pressure responsive valve includes a third flow condition when the pressure differential between the first and second chamber exceeds a second selected pressure valve.
